(19) United States
(12) Patent Application Publication
(10) Pub. No.: US 2006/0060721 A1
(43) Pub. Date: Mar. 23, 2006

(54) Scalloped leading edge advancements

(76) Inventors: Phillip Watts, Long Beach, CA (US); Frank Elliot Fish, Downingtown, PA (US)

Correspondence Address: THE LAW OFFICE OF JOHN A. GRIECCI, 703 PIER AVE., SUITE B #657, HERMOSA BEACH, CA, 90254, US

(21) Appl. No.: 11/093,722

(22) Filed: Mar. 30, 2005

Related U.S. Application Data
(60) Provisional application No. 60/557,383, filed on Mar. 30, 2004.

(51) Int. Cl. B64C 21/10

(52) U.S. Cl. 244/200

(57) ABSTRACT

An apparatus to modify a wing to provide increased lift over drag ratios and reduced noise compared to similar wings with straight leading edges. For wings extending in a lateral direction, and defining a longitudinal upstream direction, the apparatus forms a laterally extending leading edge facing in the upstream direction. The apparatus forms a plurality of protrusions spaced laterally along the leading edge, the protrusions creating a smoothly varying, alternately forward-and-aft sweep along the leading edge relative to the upstream flow direction along the leading edge. The protrusions may contain instruments, and may be deployable and retractable.

This application claims the benefit of U.S. provisional Application No. 60/557,383, filed Mar. 30, 2004, which is incorporated herein by reference for all purposes.

The U.S. Government has a paid-up license in this invention and the right in limited circumstances to require the patent owner to license others on reasonable terms as provided for by the terms of Contract No. N00014-00-C-0341, awarded by the US Navy Office of Naval Research.

### BACKGROUND

This invention relates generally to a streamlined body (e.g., a wing having an airfoil cross-section that is either symmetric or cambered) and, more particularly, to improvements on the use of a streamlined body having a scalloped leading edge configured to maximize the body's lift while minimizing the body's drag.

Designing the lift over drag ratio of a wing (or other streamlined body) for the efficient production of lift, while producing a minimal level of drag, is a normal aspiration for a wing designer. The efficiency of a wing directly correlates to the overall fuel required for a flight, which can significantly impact the overall cost of operating an aircraft. Therefore, it is highly desirable to have an apparatus for improving the efficiency of a wing. It is further desirable to have an apparatus for improving the maneuverability of a wing.

Numerous types of apparatus have been designed to affect the aerodynamics of aircraft wings. Many of these apparatus can be divided into three categories: slats; strakes and vortex generators. Slats are deployable leading edge devices that enlarge the wing area to increase lift. Typically a slat will extend the leading edge of the wing in a forward and downward direction to increase both the chord and the effective thickness or camber of the wing. The extension and/or retraction of a slat can be driven either by an actuator or by aerodynamic forces. Slats are found on most commercial aircraft and are used primarily during landing. While slats do increase lift, they also appreciably increase drag. Furthermore, slats are active devices, adding significantly to the cost of manufacturing and maintaining the wing. Such mechanical devices also require actuators such as motors and/or hydraulics, and thus further add to the weight of a wing.

Strakes are a category of typically passive fin-type devices that generally extend from the leading edge of a wing or other aerodynamic structure. Strakes are used for any of a variety of reasons relating to controlling the flow of air over a wing. Depending on the manner in which they are used, strakes can be used to modify airflow so as to either increase the wing's lift or decrease the wing's drag. However, the use of strakes is primarily limited to aerodynamic structures that have airflow occurring in undesirable patterns along the surface of the structure.

Vortex generators are typically small protrusions across the airflow that are generally placed on the low pressure side of an airfoil. As indicated by their name, the vortex generators typically have discontinuities that create vortices. Typically these vortices help maintain a boundary layer of flowing air attached to the wing. When the air separates, it causes wing stall, loss of vehicle control, and catastrophic crashes. Vortex generators cause additional parasitic drag.

Scalloped Leading Edges:

In response to this need for an apparatus for improving the efficiency of a streamlined body, the scalloped leading edge was developed. The scalloped leading edge provides improved efficiency in a streamlined body, such as a wing. More particularly, the scalloped leading edge typically provides for increased lift over drag ratios compared to similar streamlined bodies with substantially unscalloped (e.g., straight) leading edges.

Wings are bodies that extend in a (generally) lateral direction, and define a longitudinal upstream direction. They have a laterally extending leading edge facing (generally) in the upstream direction. Other relevant streamlined bodies can similarly be said to extend laterally, with respect to some reference system, defining a leading edge facing (generally) in an longitudinally upstream direction. The scalloped leading edge typically features a plurality of protrusions spaced laterally along the leading edge, the protrusions creating a smoothly varying, alternately forward and rearward sweep (or greater and lesser sweep) along the leading edge (relative to the upstream flow direction along the leading edge). It is believed that an advantage of this feature is that it creates lateral air flow along the leading edge of the streamlined body, thereby limiting the creation of high static pressure stagnation points along the leading edge. Furthermore, the feature introduces streamwise vortices near the leading edge, and lowers tip vortex strength and the related induced drag by compartmentalizing low pressure regions.

Another feature of the scalloped leading edge is that the protrusions are preferably separable from the remainder of the laterally extending wing and/or streamlined body. This feature advantageously allows the protrusions to be manufactured separately from, and even significantly after, the manufacture of the remainder of the streamlined body. It also potentially allows the protrusions to be lightweight structures that can be structurally supported by the streamlined body. Preferably, it is inexpensive, non-load bearing, and held in place by fluid-dynamic forces.

In some flight regimes, the use of scalloped protrusions may not be preferable. Moreover, a wing can often pass through a plurality of flight regimes. The use of scalloped protrusions may not be preferable for some of these regimes, but not others.

### SUMMARY

In various embodiments, the present invention solves some or all of the needs mentioned above, along with others not mentioned, providing a wing-type apparatus with certain features. More particularly, for an apparatus defining a longitudinal upstream direction, the invention may include a laterally extending streamlined body, and an instrument. The streamlined body has a laterally extending leading edge facing in the upstream direction, that defines a plurality of protrusions spaced laterally along the leading edge. The protrusions creating a smoothly varying alternately forward and aft sweep to the leading edge relative to the upstream flow direction along the leading edge. The instrument is preferably located at least in part within the protrusion.

Additionally, for an apparatus defining a longitudinal upstream direction, the invention may include a laterally extending streamlined body wherein the protrusions are configured to be at least one of deployable and retractable, and preferably both (on a repeatable basis). As before, the streamlined body has a laterally extending leading edge facing in the upstream direction, that defines a plurality of protrusions spaced laterally along the leading edge. The protrusions creating a smoothly varying alternately forward and aft sweep to the leading edge relative to the upstream flow direction along the leading edge.

Other features and advantages of the invention will become apparent from the following detailed description of the preferred embodiments, taken with the accompanying drawings, which illustrate, by way of example, the principles of the invention. The detailed description of particular preferred embodiments, as set out below to enable one to build and use an embodiment of the invention, are not intended to limit the enumerated claims, but rather, they are intended to serve as particular examples of the claimed invention.

### BRIEF DESCRIPTION OF THE DRAWINGS

FIG. 1A is an exploded perspective view of a wing section under a first embodiment of a scalloped leading edge.

FIG. 2B is a perspective view of the wing section depicted in FIG. 1.

FIG. 2 is a plan view of the wing section depicted in FIG. 1

FIG. 3A is a cross-sectional side view of the wing section depicted in FIG. 1, taken along line A-A of FIG. 2.

FIG. 3B is a cross-sectional side view of the wing section depicted in FIG. 1, taken along line B-B of FIG. 1.

FIG. 4 is a plan view of an aircraft under a second embodiment of a scalloped leading edge, having a swept wing.

### DETAILED DESCRIPTION OF THE PREFERRED EMBODIMENTS

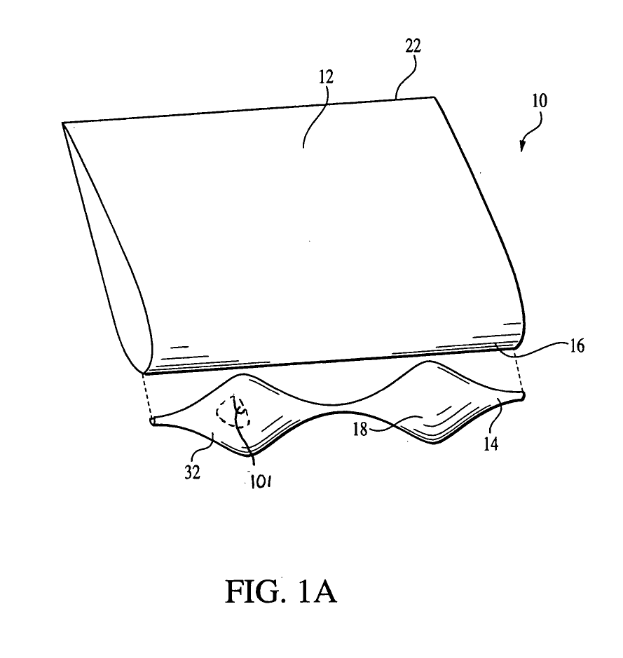

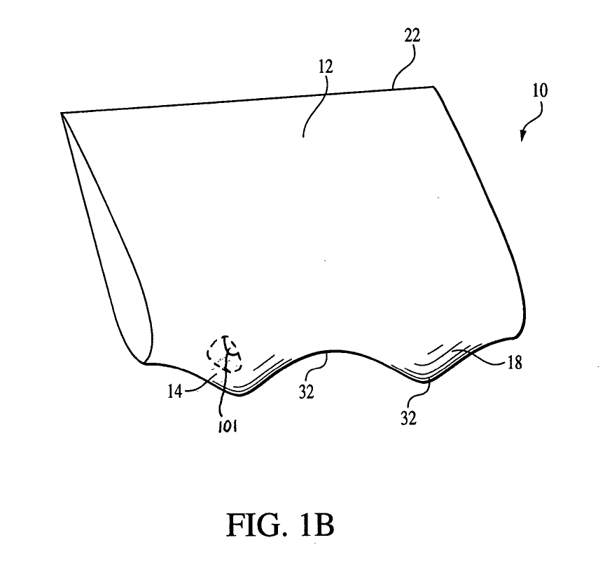

A section of a wing 10 according to one embodiment of a scalloped leading edge is shown in FIGS. 1A and 1B. The wing is a laterally extending body having a laterally extending primary portion 12 and a laterally extending leading portion 14. The primary portion forms an unswept wing characterized by a constant chord and cross-sectional airfoil shape, and by a straight, laterally extending leading edge 16. The leading portion of the body is disposed along the leading edge of the primary portion, and is scalloped, i.e., it forms protrusions 18 that extend forward significantly from the leading edge.

The wing 10 can be configured for a broad array of functions. Many typical vehicles, such as aircraft, watercraft (both surface and submersible), and land vehicles, use horizontal, vertical and/or canted wings for creating lift, stabilizing airflow, maneuvering, and/or creating other aero- and/or hydrodynamic forces. Similarly, various apparatus that handle fluids (i.e., liquids or gasses), and particularly ones that handle large quantities of fluids, employ wing structures to direct the flow of the fluids, stabilize the fluids, measure the flow rate of the fluids, and other such functions.

With reference to FIGS. 1A-3B, the primary portion 12 of the wing 10 is constructed using conventional techniques for the type of wing that is being designed. For example, if the wing is being designed for a typical commercial aircraft, the wing will likely include one or more longitudinally extending spars, with a series of frames at longitudinally spaced locations along the spars, and a skin panel that is attached around the frames to form the exterior shape of the body. If the wing is being designed for a car spoiler, the primary portion will likely be a composite structure that is solid throughout.

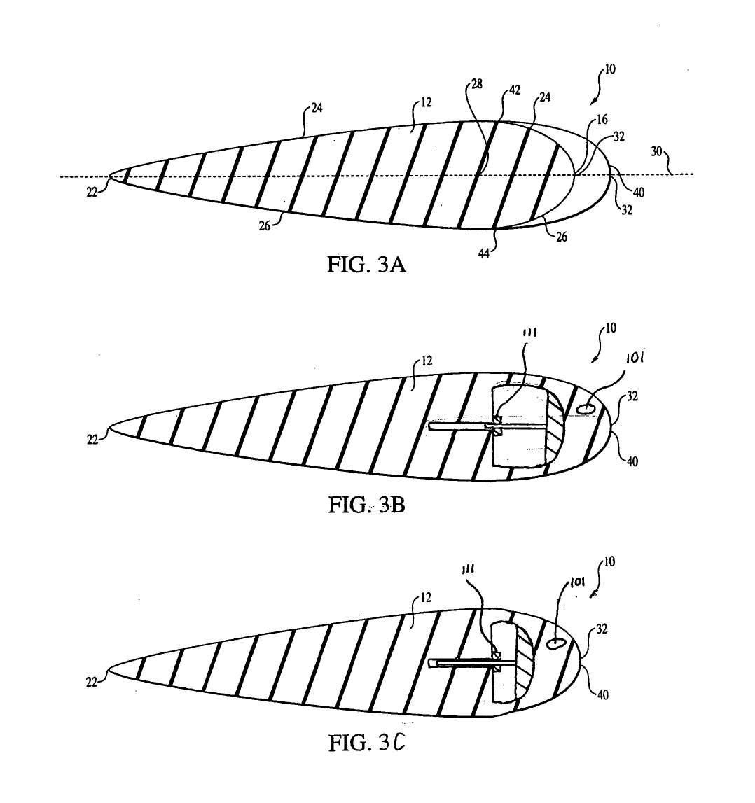

Preferably, the cross-section of the primary portion 12 (depicted in FIGS. 3A and 3B) is characterized by an airfoil shape, with a rounded leading edge 16, a sharply pointed trailing edge 22, and a smoothly varying upper and lower camber 24 and 26, respectively, in between. The camber reaches its maximum thickness at approximately a quarter-chord or 30% chord location 28 (i.e., the maximum thickness of the primary portion is spaced from the leading edge by approximately 25% or 30% of the distance between the leading and trailing edges). Whether the upper and lower camber are symmetric to the chord line 30 will depend on the function that the wing is being designed for, as is known in the art.

As noted above, the leading portion 14 forms a series of protrusions 18 that define a leading edge 32 for the wing as a whole. It can be designed either as a single, unitary structure (as depicted) or as a plurality of parts (not shown). In the latter case, each part can include either a single protrusion or a plurality of protrusions. The leading portion is relatively small in comparison with the primary portion 12, and will typically be primarily supported by the support structure of the primary portion. Therefore, the leading portion will not be as likely to need spars, supports or exceptionally high strength materials that might well characterize the primary portion. Instead, it can be made to minimize weight and cost.

The method of attachment used to affix the leading portion 14 to the primary portion 12 will be selected from among the types of methods typically used for the particular application. On an aircraft wing, for example, the leading portion could be riveted to the primary portion at the longitudinal locations of the frames, with additional attachments at spaced intervals along the wing skin. Alternately, the primary portion and leading portion can be formed as a unitary member. This might be particularly desirable for simpler structures, such as that of a car spoiler. In such a case, there would be no need for an underlying primary structure with a leading edge. Instead, it could be one solid piece, or a wing with spars, frames, and other structures to support the scalloped leading-edge's shape.

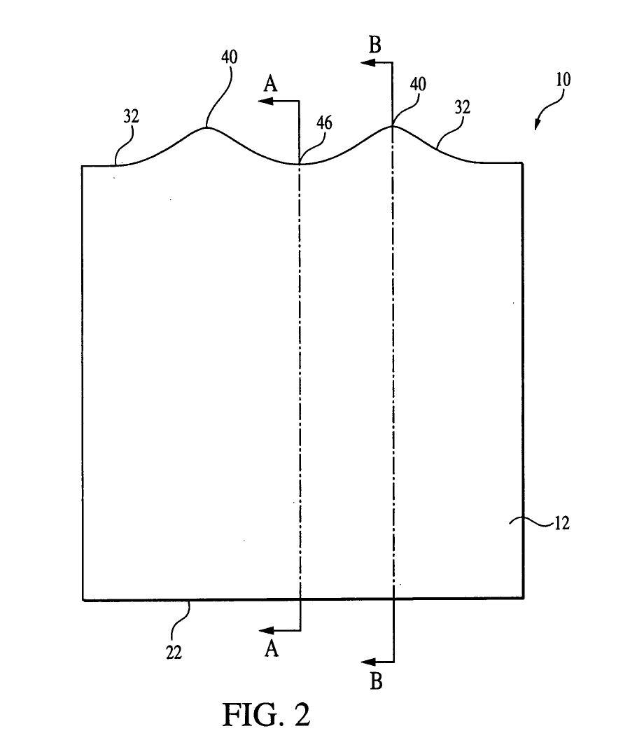

As seen in FIGS. 2, 3A and 3B, at the longitudinal peak 40 of each protrusion 18 (i.e., the longitudinal location along the wing of the protrusion's fore-and-aft peak), the protrusion preferably extends back substantially to the points 42 and 44 at which the upper and lower cambers 24 and 26 reach their maximum height. This can occur at a different fore-and-aft position on the upper camber as opposed to the lower camber. Thus, the resulting upper and lower camber of the combined leading and primary portions is preferably an elongated variant of the primary portion's upper and lower camber.

At the bottom 46 of the fore-and-aft trough between each succeeding protrusion (see FIG. 2), optionally being laterally equidistant from the peak 40 of each protrusion, the leading portion 14 might add little to no shape to that of the primary portion 12. Thus, the resulting upper and lower camber of the combined leading and primary portions is preferably substantially the same as the primary portion's upper and lower camber. However, this might not be true near the root and/or tip of a wing that otherwise fits this description.

In between each trough 46 and peak 40, the wing's leading edge 32 varies in a fore-and-aft direction in an approximately smooth and oscillatory manner, thus creating an alternating forward and rearward sweep along the leading edge of the wing. The maximum fore-and-aft slope (i.e., change in fore-and-aft direction verses longitudinal location) of the leading edge reaches roughly the same magnitude on each side of each trough, although opposite in sign.

The forward extension distance that the leading portion 14 adds to the camber of the primary portion 12 varies smoothly, thus forming a smoothly varying set of forward protrusions on a wing that otherwise has a relatively constant chord and airfoil. However, it is to be understood that scalloped leading edges can be applied to a wide variety of wings, including wings that already have varying chords, sweeps, and cambers. It is to be understood that application of a scalloped leading edge to a swept wing might lead to a wing with a leading edge having a leading edge sweep that repeatedly varies between smaller and larger values of the same sign. For example, a highly rearward-swept wing with small protrusions that extend forward and outward at an angle normal to the sweep of the wing might not have any forward-swept portion of its leading edge. Also, it should be clear that rearward-swept wings will likely have outboard protrusions located in a more rearward (i.e., downstream) position, and forward-swept wings will likely have outboard protrusions located in a more forward (i.e., upstream) position.

The longitudinal spacing and/or amplitudes (i.e., the distance that the fore-and-aft peak extends forward) of the protrusions preferably increases in a portion near a wing root and decrease in a portion near a wingtip (relative to more centrally located protrusions). The wing root and wing tip portions each commonly constitute 20-30% of the wing, the remaining 40-60% being a center portion. Wing roots and wingtips can sometimes be defined by changes in a wing's chord, camber, sweep and/or dihedral, as well as the placement of attached items such as pylons.

In the case of wings with distally decreasing chords (i.e., where the minimum chord between each adjacent pair of protrusions decreases distal from a center point), or with wings having wing sections that have decreasing chords, the protrusions preferably decrease in size corresponding to, and preferably proportional to (or otherwise related to), the decrease in chord, the decrease in maximum height, or some proportional/related combination of the two. Additionally, it is preferable that the distance between each peak and trough proportionately decrease, such that tapered wings have protrusions of increasing frequency and decreasing size.

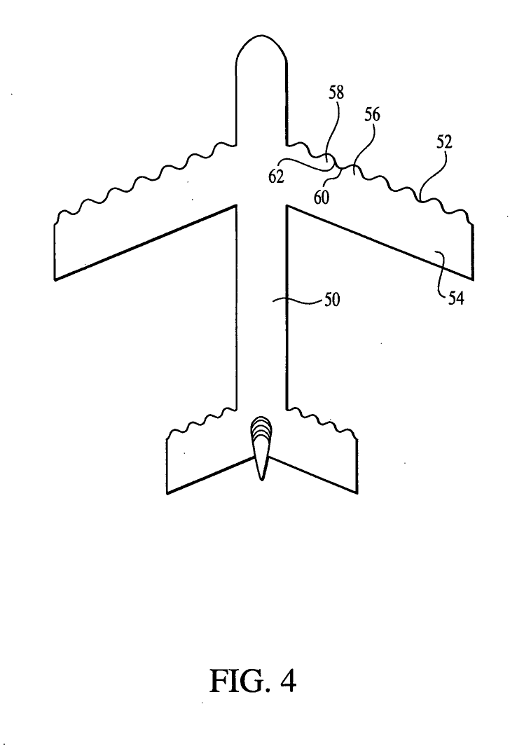

With reference to the aircraft 50 of FIG. 4, if the leading edge 52 of the primary portion 54 is swept back or forward (i.e., it is not zero), the wing forms pairs of adjacent protrusions where, relatively, one is aft 56 and one is forward 58. The lateral center point 60 of the fore-and-aft trough 62 preferably moves toward the aft protrusion 56, thus allowing the maximum fore-and-aft slope of the leading edge to reach at least roughly the same value on each side of each trough.

In experimentation, the scalloped leading edge has proven to typically both increase lift and lower drag at relatively modest angles of attack up to 16°. Even when no increase in lift was detected near zero angle of attack, there continued to be no drag penalty. Thus, in experimentation the scalloped leading edge has proven to consistently have an equal or higher lift over drag ratio, and incurs no penalty in wing performance. Other preferred embodiments are anticipated to likewise have this advantage.

It is believed that the scalloped leading edge will likewise function at higher angles of attack, and that it will delay the onset of stall through these higher angles of attack, thereby extending the useful operating envelope of lifting surfaces and control surfaces.

The scalloped leading edge appears to function by altering the typical aero- or hydrodynamics occurring over an airfoil. In particular, in cross-section a typical airfoil will have a stagnation point on the leading edge, where the fluid particles have zero velocity with respect to the airfoil. In front of the stagnation point is a stagnation region, where the fluid has negligible relative velocity. The reduction of the relative speed to zero creates a significant pressure on the wing, and therefore, a significant amount of drag. On a typical wing, a line of stagnation points are thus present longitudinally along the leading edge of the wing, creating a line of high static pressures along the leading edge of the wing. Airfoil drag in a viscous fluid can be reduced by decreasing the size and strength of high static pressure regions. In other words, lower leading edge static pressures improve airfoil leading edge suction. Typically, one stagnation point exists at each peak and trough along the leading edge, while the remainder of the leading edge experiences lower static pressures.

In a first advancement regarding scalloped leading edges, the protrusions 18 are configured and used to house instruments 101. The instrument is located, at least in part in one or more scallops. More particularly, the instrument could be located totally within (or on) a single scallop, it could be divided into parts and located within (or on) several scallops, it could be located partially within (or on) the scallop and partially in (or on) the remaining parts of the streamlined body or other related structures.

Included among the types of instruments that could be used are: various sensors including pressure sensors including pitot tubes for measuring pressure and/or velocity, optical sensors such as cameras, chemical sensors, magnetic sensors, sound sensors (e.g., hydrophones), and electromagnetic antennae; various emitters including optical emitters such as lasers and lights, chemical sprayers, magnetic emitters, sound emitters, and electromagnetic transmitters, and combinations of the two such as might be found in sonar equipment, radar equipment, and communications equipment (e.g., laser or radio transceivers). As implied by the instrument types, these instruments can have many different functions, such as vehicle control (e.g., lights, radar, or sonar), communication, environmental monitoring, signal location, and the like.

Preferably these instruments are of a type that would have benefits associated with being located on the scalloped leading edge. For example, if the scalloped leading edge is on a statically positioned turning vane in a liquid-carrying pipe, the instruments might be sensors configured to sense objects upstream in the pipe, or to sense properties of the passing liquid.

As a second example, if the leading edge is on an aircraft wing, the instruments might be ones that have an unobstructed forward-, upward-, lateral- (on a rearward-swept wing) and/or downward-viewing preference. Likewise, the instruments or the aircraft might benefit from the instruments being positioned remotely from the aircraft fuselage or from other instruments, such as to view the fuselage, to avoid obstruction by the fuselage, to provide for triangulation, or to avoid interference with other instruments located in the fuselage or elsewhere on the wing.

Advantageously, the use of the scallops to house instruments avoids the instruments being put in wing-mounted or fuselage-mounted pods that are typically detrimental to aircraft aerodynamics. Also, on many wings the addition of weight forward of the wing has neutral or beneficial effects from the standpoint of flutter and vibration. Thus, the instruments are added to the aircraft in a manner that is beneficial, or at least not detrimental, to the performance of the aircraft.

Furthermore, by incorporating the instruments into leading edge portions as described with reference to FIG. 1A, the instruments can be removed and replaced by simply removing the leading edge portion. Alternatively, the leading edge portions can be removable to allow service access to the instruments. In any case, the leading edge portion can also contain support equipment for the instruments, such as power sources or data storage devices.

In a second (and in some embodiments related) advancement, the streamlined body includes leading edge scallops that are deployable, retractable or both. More particularly, the streamlined body is configured to deploy and/or retract scallops, providing control over whether the leading edge is substantially unscalloped (e.g., straight or continuously curved without protrusions), or substantially scalloped (with respect to aerodynamics).

It is to be understood in this context, that the term substantially unscalloped is used in reference to the presence of scallop protrusions, rather than to a leading edge shape based on the overall wing configuration. For example, a two-part wing with a bent leading edge that has a first sweep in a first lateral wing portion and second sweep in a second lateral wing portion, is considered to have a substantially unscalloped leading edge if it lacks scallops, even though it is characterized by a leading edge forming two separate lines along the leading edges of the two lateral wing portions. Likewise, a continuously curving leading edge that lacks the characteristic plurality of protrusions is considered to be substantially unscalloped.

It is also to be understood that the term deploy is meant to broadly refer to a process undergone by any mechanism capable of transforming the leading edge from a substantially unscalloped configuration to a substantially scalloped configuration, regardless of whether portions of the mechanism translate, rotate and/or deform. Likewise, the term retract is meant to broadly refer to a process undergone by any mechanisms capable of transforming the leading edge from a substantially scalloped configuration to a substantially unscalloped configuration.

One embodiment of a deployable and retractable scallop mechanisms comprises a wing having a flexible leading edge that deploys scallops by having an actuator 111 apply forward-directed forces to the leading edge at each scallop location. Another embodiment is configured with a flexible leading edge that is laterally compressed (i.e., compressed parallel to the leading edge) by actuator pairs pushing toward one-another to create a force couple at each scallop location. The compressed leading edge expands through Poisson effects, providing scallops. Similarly, the leading edge could include a material that expands under stimulation, such as with the application of electrical or thermal stimulation, to provide bulges that form scallops. In appropriate configurations, such stimulation could also serve a de-icing function.

Preferably, the deployable and/or retractable scallop mechanisms are deployable and/or retractable during the operation of the streamlined body. Thus, a suitably equipped aircraft could deploy the scallops in flight regimes where they are advantageous, such as lower speed flight, and retract them in flight regimes where they might be less desirable, such as transonic flight. Likewise, a suitably equipped ship could deploy the scallops in regimes where they are advantageous, such as during low loads, and retract them in regimes where they might be less desirable, such as under high loads where cavitation is more likely to occur.

This advancement has particular synergies when used with scallops configured and used to house instruments. More particularly, depending on the nature of the deployment mechanism, the use of deployable leading edge scallops for instrument storage potentially provides for the use of the deployment mechanism to control the timing, position and/or orientation of instrument deployment, as well as allowing for some fine-tuning of instrument operation. Also, upon retraction, the deployment mechanism could be configured to provide the instruments additional protection beyond that available while they are in operation.

In a third advancement regarding scalloped leading edges, the scallops are used to clean and/or straighten out fluid flows, and thereby to reduce noise. More particularly, noise reduction can be achieved on a variety of military and civilian platforms, such as submarine fins and propellers, ship rudders and propellers, jet engine stators and rotors, helicopter blades, and the like.

In the terminology of this application, “noise reduction” can refer to the reduction of external noise (i.e., vibrations detectable outside of a craft), external turbulence (i.e., flow perturbations affecting the wing's flow through the fluid), internal noise (i.e., vibrations detectable inside of a craft), and/or structural noise (i.e., structural vibration). In various applications each of these types of noise have varied levels of relevance. Therefore, this method of reducing noise (or of operating in a quiet regime) has related methods of reducing external noise, reducing external turbulence, reducing internal noise, and/or reducing structural noise.

Leading edge scallops can be used alone, or in combination with other noise reduction devices. Such other devices operate by various means, such as delaying stall or fluid flow separation, increasing efficiency, controlling the location and orientation of separation layers in the flow, or the like.

This advancement has particular synergies when used with deployable and/or retractable leading edge scallops. More particularly, the use of leading edge scallops for noise reduction potentially defines additional regimes in which the deployable and/or retractable leading scallops would be used. For example, when a submarine desired noise reduction on its fins and propellers, leading edge scallops could be deployed on those devices, and when the noise reduction was no longer desired, the leading edge scallops could be retracted.

This advancement also has particular synergies when used with scallops configured and used to house instruments. More particularly, the noise reduction might provide a preferable operating environment (e.g., an environment providing for fewer vibrations and fluctuations; improved signal to noise rations; less measurement interference; better accuracy and precision; and/or improved instrument reliability and lifespan). Furthermore, when these two advancements are combined with deployable scallops, additional synergies occur, such as to provide for an improved environment for instrument operation while the scallops are deployed, while allowing for better aerodynamic operation in regimes where the scallop deployment is not desirable.

From the foregoing description, it will be appreciated that the present invention provides apparatuses and methods relating to improving the efficiency and reducing the noise of a streamlined body. While particular forms of the invention have been illustrated and described, it will be apparent that various modifications can be made without departing from the spirit and scope of the invention. Furthermore, it is understood that a wide range of applications exist, such as for aircraft, water craft and land vehicles, including rudder leading edges, submarine dive planes and conning towers, sailboat keels, sailboat masts, spoilers, stators, rotors, fans and various appendages. Thus, although the invention has been described in detail with reference only to the preferred embodiments, those having ordinary skill in the art will appreciate that various modifications can be made without departing from the invention. Accordingly, the invention is not intended to be limited, and is to be defined only with reference to the claims provided herein or subsequently submitted.

What is to be claimed is:

1. An apparatus defining a longitudinal upstream direction, comprising:
a laterally extending streamlined body having a laterally extending leading edge facing in the upstream direction, wherein the laterally extending body defines a plurality of protrusions spaced laterally along the leading edge, the protrusions creating a smoothly varying alternately forward and aft sweep to the leading edge relative to the upstream flow direction along the leading edge; and
an instrument located at least in part within the protrusion.

2. The apparatus of claim 1, wherein the protrusions are separable from the remainder of the laterally extending body.

3. An apparatus defining a longitudinal upstream direction, comprising:
a laterally extending streamlined body having a laterally extending leading edge facing in the upstream direction, wherein the laterally extending body defines a plurality of protrusions spaced laterally along the leading edge, the protrusions creating a smoothly varying alternately forward and aft sweep to the leading edge relative to the upstream flow direction along the leading edge;
wherein the protrusions are configured to be at least one of deployable and retractable.

4. The apparatus of claim 3, and further comprising an instrument located at least in part within the protrusion.

5. The apparatus of claim 4, wherein the wing includes a mechanism to control the deployment of the protrusions, the deployment mechanism being configured to control at least one of the timing, the position and the orientation of instrument.

6. A method of reducing the generation of noise by a wing, wherein the wing is laterally extending and defines a leading edge facing in a longitudinal upstream direction of a flowing fluid, comprising:
providing the leading edge of the wing with a plurality of protrusions spaced laterally along the wing's leading edge, the protrusions creating a smoothly varying alternately forward and aft sweep to the leading edge relative to the upstream flow direction along the leading edge;
wherein the step of providing comprises deploying protrusions that are configured to be deployed while in a flowing fluid.

7. The method of claim 6, wherein the wing includes an instrument located at least in part within the protrusion, the instrument being subject to generated noise such that the deployment of the protrusions provides a preferred operating environment for the instrument.
